(19) United States
(12) Patent Application Publication
(10) Pub. No.: US 2004/0123245 A1
(43) Pub. Date: Jun. 24, 2004

(54) Intellectual property geographic mapping

(76) Inventors: David J. Bianchi, Peoria, IL (US); Judith A. Bright, Marquette Heights, IL (US); Judy F. Wheat, Tremont, IL (US)

Correspondence Address: CATERPILLAR INC., 100 N.E. ADAMS STREET, PATENT DEPT., PEORIA, IL, 616296490

(21) Appl. No.: 10/327,489

(22) Filed: Dec. 20, 2002

(51) Int. Cl. G06F 17/21

(52) U.S. Cl. 715/526

(57) ABSTRACT

A computer-implemented method of displaying intellectual property is disclosed. The intellectual property data is retrieved from at least one repository. A geographic map region is then associated with a code based on the data. Then, a region is displayed based on the code. The intellectual data may be associated with an invention, a mark or a work of authorship.

### TECHNICAL FIELD

The present invention relates generally to a method and system of displaying intellectual property data and more particularly to a method and system of displaying information associated with intellectual property data on a geographic map.

### BACKGROUND

Currently, a person interested in determining intellectual property coverage by geographic region must use a spreadsheet or manually track the information on a map. The spreadsheet will not graphically show the coverage of the intellectual property. To achieve graphic representation of the intellectual property coverage or lack thereof, a person may manually track the intellectual property coverage with push-pins or other marking methods. For example, a person may choose blue as the color for patent granted. The person would put a blue push-pin in a map for each country that the patent had been granted in. The person would obtain this information from searching data repositories or from paper based files.

Alternatively, coverage by geographic region or other forms of data may be tracked by manually entering the data into mapping software programs, which are available commercially. For example, with respect to political coverage, a person may want to see which states voted for a particular presidential candidate (e.g., Republican or Democrat). The person may designate red as the color to signify those states that supported the Republican candidate and blue for the states that supported the Democratic candidate. The person would manually input those states supporting the Republican candidate into the software program which would attribute the color red to those states inputted and display a map with the appropriate states red. However, systems such as these perform no analysis on the data, such as analysis associated with intellectual property data.

The present invention is directed to overcoming one or more of the problems set forth above.

### SUMMARY OF THE INVENTION

In one aspect of the present invention, a computer implemented method of displaying at least one geographic map region is disclosed. The method includes the steps of retrieving intellectual property data from at least one repository, associating the geographic map region with a code in response to the intellectual property data and displaying the geographic map region based on the association.

In another aspect of the present invention, a computer system is configured to display at least one geographic map region. The computer system comprises at least one repository configured to store intellectual property data, a controller configured to retrieve intellectual property data from the repository, associate the geographic map region with a code in response to said intellectual property data, and send the data to an output device for display of the geographic map region in response to the association; and an output device configured to receive the information associated with the code, and responsively display the geographic map region.

### BRIEF DESCRIPTION OF THE DRAWINGS

FIG. 1 is a diagram of the computer system associated with the present invention; and,

FIG. 2 is an illustration of one embodiment of a method of displaying a geographic map region.

### DETAILED DESCRIPTION

The present disclosure is associated with a computer-implemented method and system of displaying intellectual property data associated with a geographic map region. The intellectual property data may include invention, work of authorship, or mark data. The invention data may include issued patent data, data from a filed application that has not yet been granted, or data associated with abandoned patents or patent applications or defensive publications. The patent data may be associated with the United States, and/or one or more foreign countries or organizations. The work of authorship data may include works that are protected by United States copyright law, or similar laws in other countries. The work of authorship data may also include any published works not protected by similar copyright laws, in any countries, states, or other regions. Mark data may include trademark or service mark data associated with a mark.

A geographic map is used to illustrate characteristics associated with the intellectual property data, as will be described. The geographic map region is comprised of regions such as, a country, state, continent or other geographic land mass.

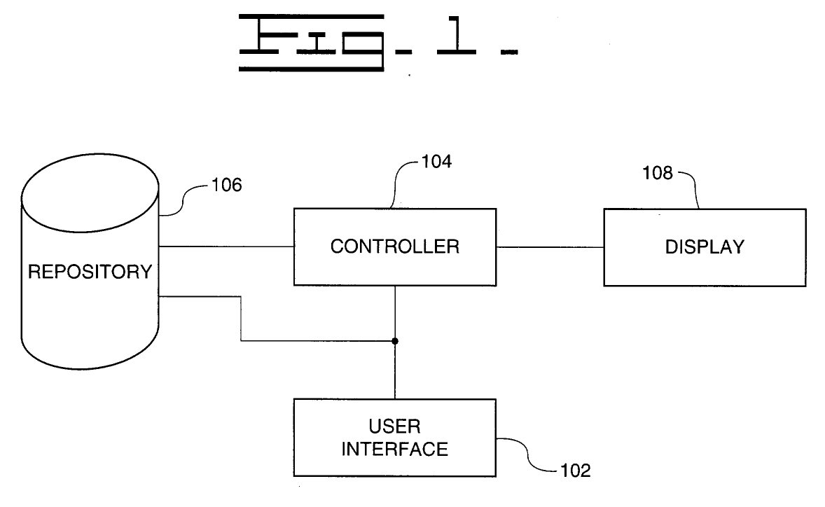

FIG. 1 illustrates one embodiment of a system configured to display a geographic map region 108. Intellectual property data may be stored in one or more repositories 106. The repositories 106 may include one or more local repositories, remote repositories, or both. The repository 106 may be a government repository like the United States Patent and Trademark Office (USPTO), a company controlled repository, or a repository controlled by a third party. The repository may be based on commercial software such as Aurigin or PC Master or other commercial intellectual property management software that is available in the market. The repository may also use custom programmed software or may use a legacy system to store the intellectual property data.

Controller 104 may be an electronic processor, or other device that performs analysis, or a search associated with the intellectual property data stored in the repository 106. In particular, the controller 104 may include software capable of performing analysis or search functions associated with the intellectual property data. In one embodiment, the controller 104 may query at least one repository 106 based on a search request developed by a user, e.g., through a user interface 102. Alternatively, the controller 104 may automatically generate the query. The controller 104 may query at least one repository 106 based on a search request prepared by the controller 104 as a result of at least one of computer and software programming instructions. For example at least one of, a computer, computer system, software program or other electronic means may generate the request to determine the coverage/status of a particular patent, receive the search results, associate a geographic map region with a color code in response to the coverage and status of the application, and then display the color coded geographic map region(s). The controller 104 is connected to the repository 106 by connection to at least one of a computer network, the Internet, an extranet, an intranet, a wireless communication link, a wide-area-network, a personal digital assistant, and a cellular phone.

Display 108, also referred to as an output device, may be at least one of a computer monitor, liquid crystal display (LCD), television monitor, electroluminescent display (ELD), flat-panel display, gas-plasma display, LCD monitor, LCD printer, super-twist, super-twist nematic display (STN), color super-twist nematic (CSTN), double-layer super-twist nematic (DSTN), active-matrix display, passive-matrix display, and thin film transistor (TFT). The shades of the output of the display 108 may be at least one of black and white, color, and gray scale. The display 108 receives a signal from at least one of the repository 106 and controller 104. The signal may be transferred from the controller 104 or repository 106 to the display 108 by at least one of a network, computer, electronic device, repository and controller.

In one embodiment, the system includes a user interface 102. The user interface 102 may be a keyboard, personal digital assistant, voice command, pull-down-menu, touch-screen or wireless communication device. In one embodiment a user may input a request or a search query through the user interface 102 via the Internet, a dedicated network, electronic signal, or other computer network system. The user interface 102 may include processing capability and be capable of developing a search query, and then searching the repository 106 based on the query.

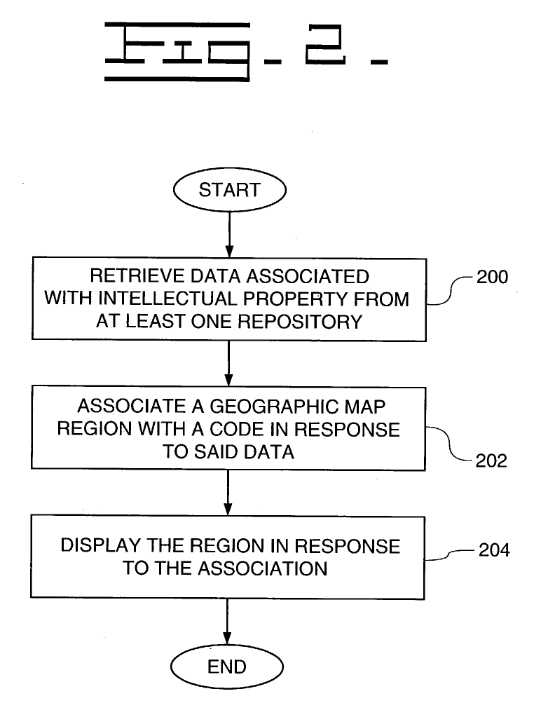

FIG. 2 is one embodiment of a method associated with the present invention. In a first control block 200, intellectual property data is retrieved from at least one repository. In one embodiment a query is formulated to conduct the retrieval of the intellectual property data. For example, the query may include a request to determine the countries in which a particular patent or patent application is filed. Therefore, the query may include the patent number, or patent application serial number, or other form of identifier, (e.g. internal docketing number). At least one of the repositories is searched based on the query. The query may specify one or more repositories to be searched. In one embodiment, if no repository is listed then one or more default repositories may be queried. In one embodiment, the query may also include an intellectual property topic, e.g., invention, mark, or work of authorship. The intellectual property topic may enable the user interface 102 or controller 104 to understand which repository to search and/or how to configure the search request, if no repository was specified. The result of the query may include a list of countries where associated patent applications have been filed, including the status in each country filed. The status may include at least one of pending, abandoned, and issued.

In the event the query is related to a mark, the query may include a core term, e.g., the mark “Caterpillar”. The query may also include the associated class in which the mark is to be searched. The result of the query may be a list of countries in which the mark has been registered, the class the mark was registered, and what goods or services the registered mark is associated with, or registered with.

In a second control block 202, a geographic map region is associated with a code in response to the intellectual property data 202. The code may be a color-code, a line-code, a shading-code or a three-dimension code. In one embodiment the intellectual property data is correlated with the code and then the coded data is correlated with a geographic map region. For example, the status of a patent application may include: issued, pending, or abandoned. The color code blue may be assigned to patent pending, the color code green to patent issued, and the color code red to patent abandoned. If the retrieved information indicates an invention, e.g., internal docket number 99-222, has been filed in France but has not issued, then the patent is pending in France. The geographic map region may then be associated with the color blue. Therefore, the retrieved information indicates the location intellectual property data was filed, and the associated status. The geographic map region (France) is associated with the color code blue in response to the intellectual property data (the patent pending in France, and blue represents patent pending).

A color-code may include at least one of, a color spectrum, a black and white spectrum, and a gray-scale spectrum. A color spectrum is comprised of at least one color, not including the colors black and white. A black and white spectrum is comprised of at least one of the colors, black and white. A gray-scale spectrum is comprised of at least one shade of the color gray. A line-code may include at least one object with at least one line drawn through it. A shading-code may include at least one shade of at least one color. A three-dimension code may include at least one object visualized in three-dimension.

In a third control block 204, the geographic map region is displayed based on the code association. The geographic map region may be associated with a world map in multiple dimensions. Therefore, in the embodiment mentioned above, the geographic map region (France) would be displayed in response to the color code association (the patent is pending in France, and the color code associated with a pending application is the color blue). The geographic map region may be at least one of a country, territory, and a land mass, and may be displayed in multiple dimensions.

In one embodiment, the system includes a user interface 102. Therefore, the user may formulate a query, using the user interface 102, to search one or more repositories 106. In one embodiment, the result of the query is the retrieval of the intellectual property data from at least one repository.

The query, whether generated by the controller 104 or based upon user inputs, may include information associated with desired intellectual property data. For example, the query may include at least one of a topic, term, and an attribute associated with the desired intellectual property. In one embodiment, the topic may include information associated with at least one of an invention, a mark and a work of authorship. The invention information may include information associated with at least one of, a docketed invention (docket number), issued patent (patent number), patent application (serial number), a technology, a process, and an invention portfolio. A patent may include any patent issued by a country (e.g., a patent issued by the USPTO). A patent application may include any patent application submitted to a patent office but not yet issued, or denied. A technology may include a group of similar inventions associated with a particular technology. For example inventions related to computers or software programs may be grouped as a computer technology. A process may include a business method. A process may be scalable and therefore not confined to a specific technology group. An invention portfolio may include at least one of a grouping of technologies, patents, patent applications and processes. In one embodiment an invention portfolio allows for the management of groups of intellectual property data by sorting similar intellectual property data. The mark information may include information associated with a mark, such as the mark itself and the class the mark is registered (if it has been).

The term may include at least one of a word, phrase, a number and symbol. The term is generally associated with a mark. A phrase may include at least one word. Alternatively, a phrase may include a combination of at least one of a word, a number and a symbol. A number may include at least one of an integer, a decimal, a binary, a floating-point, a hexadecimal, and an octal. A symbol may include at least one of a graphical representation, a character not considered a word or phase, and an abbreviation. For example, a word may be “tree”, a phase “tree harvester”, a number “345” and a symbol “TM” (the abbreviation for trademark).

The attribute portion of the query, if used, specifies an attribute about the intellectual property data being requested. The attribute may indicate the type of information associated with the intellectual property data that is desired to be displayed, e.g., the type of analysis the controller 104 should perform on the retrieved data in order to have the desired information displayed. An attribute may be associated with at least one of a region of coverage for intellectual property data, a life remaining on the intellectual property, a term of coverage, a strength of a mark, a class of a mark, a product or service associated with a registered mark, and a similarity with the core term. A region of coverage may include at least one of, a country and a union. For example, a region of coverage may include the United States, or it may include the European Union. A life remaining on the intellectual property may include the years remaining on the term of the intellectual property. For example, U.S. patent X may have ten years remaining before the term of the patent expires at which time patent X will no longer enjoy protection under U.S. patent law. Therefore the life remaining on the patent would be ten years. If the query includes patent X, life remaining, then the user is requesting information associated with the remaining life of patent X. The query may include multiple attributes (e.g., region of coverage and life remaining). A term of coverage may include the amount of time the intellectual property is covered expressed in years. For example, in the United States the term of coverage on a patent is twenty years.

The attributes “region of coverage”, “strength of mark”, “core term”, “similarity with core term”, “class”, “associated product/service”, may be associated with marks. For example, the query may include the mark, and “region of coverage”. Then, one or more repositories may be searched to retrieve information about the mark, and in particular information about where the mark has been registered. In addition, the retrieved information may indicate what class the mark has been registered in, and what goods or services (if any) are associated with the registered mark. In one embodiment, the query may include a request to determine the strength of a mark. The query may include “Caterpillar”, region of coverage, class, strength of mark. The repository may be searched to determine which countries the mark is registered in (e.g., region of coverage). In addition, the same (or another) repository may be searched to determine the strength of the mark. There may be a local repository that includes a list of all the countries the mark is registered. There may be one or more remote repositories that include registered marks. The registered marks may be searched to determine which, if any are similar to the mark being searched. Similarity may be determined based on which marks are grammatically similar, what classes the grammatically similar marks are registered in, and what products or services are associated with the grammatically similar marks. A list of identical, or similar marks may be returned to the controller 104, and an indication of whether the base mark has been registered in the particular country. In addition, the class in which the mark has been registered and any associated product or service registrations may be returned. The controller 104 may analyze the registered marks with the base mark to determine how close the returned registered marks are. The analysis may be used to indicate that the strength of the mark is one of strong, weak, and average. Alternatively, the strength of a mark may be represented by an integer. For example, a strong mark may have the number 9 or 10 associated with it, while a weak mark may have the number 2 or 3 associated with it. If there are one or more marks that are very similar to the mark being analyzed, and the returned marks are in the same class of marks, then the controller 104 may label the strength of the mark in that particular country as weak. Therefore, even though the results indicate the mark has been registered by the user, since there are similar marks that have been registered, the strength of the mark may be established as weak. In addition, if the results indicate that the mark has not been registered by the user, but there are similar marks that have been registered in the identified class and/or are associated with similar goods or services, then a “weak” identifier indicates the mark would be difficult to acquire in that particular country. The results of the analysis may be displayed. For example, a “weak” mark may be associated with the color red, an “average” mark the color blue, and a “strong” mark with the color green. Then, a geographic map region may be associated with the color code in response to the data. Therefore, if a grammatically similar mark has been registered in the same class as a desired mark in the UK, the strength of the mark, or ability to register the mark, may be listed as “weak”, and then the geographic map region associated with the UK may be colored red. In one embodiment, the color code may be based on region of coverage, and strength of mark. For example if the trademark is registered in a particular geographic region, the region may be color coded green. If the trademark is not registered in a particular region, the region may be color coded red. Then, the strength of the mark (indicating either strength of the registered mark, or difficulty in acquiring mark registration), may be used to shade the respective color of the region. For example, the region associated with a “strong” mark where the mark has been registered may be displayed as a dark green. A light green and medium green may be used to display a region where the mark has been registered and is considered “weak” or “average” respectively. The same color shading code may be used for regions where the mark has not been registered (e.g., dark red for regions where the mark has not been registered and is analyzed as a “strong” mark, or “strong” chance of success with respect to registration). In addition, the goods or services associated with a registered mark may be textually indicated on the coded geographic map region. Alternatively, a code may be used to indicate the similarity between the goods and services associated with the registered marks, and the goods or services associated with core mark. The result may be used as a factor to determine the strength of the mark. Alternatively the displaying of the geographic map region may be performed based on the similarities of the registered goods or services. For example, the mark to be registered (or that has been registered) may be associated with a particular good or service. The good or service, or an associated class of goods or services containing the identified good or service, may be compared with goods or services (or associated classes) of the registered marks to determine if the mark to be registered is associated with the same type of goods or services. The color green may be used to indicate that the registered goods or services are not similar, the color blue may indicate that they are somewhat similar, and the color red may be used to indicate they are identical, or very similar.

A core term may include at least one of, a word, and a phrase. For example, a core term for a tree-harvesting machine may include the word “tree” or “harvesting” or may include the entire phase “tree harvesting machine”. A similarity with a core term may include at least one of, a word similar in spelling, a word similar in sound and a partial word. In addition, the similar word may be located in a similar class, and/or associated with similar goods or services. For example, the core term “Caterpillar” may have a similar sounding word “Katerpillar” or a similarly spelled word “Catterpillar”. Alternatively, a core term may include a partial word. For example, the partial word “Cat” instead of the full word “Caterpillar”.

In one embodiment, the repository may be searched based on at least one of the topic, term, and attribute. For example, a local repository may be searched to determine the status of a particular patent application. In addition, analysis may be performed on the search results based on at least one of the topic, term, and attribute (e.g., the life remaining for the patent).

A patent filed includes an invention submitted to at least one country's patent office. A patent filed may also be referred to as a patent application. A patent issued is a patent filed or patent application, which has been granted by at least one countries patent office. For example a patent application may have a Ser. No. 3,454,545 associated with the application, the number given by the USPTO. When the patent application Ser. No. 3,454,454 issues as a patent in the United States, a new number 6,777,555 would be given to the issued patent and this would be referred to as a patent; U.S. Pat. No. 6,777,555. A patent abandoned may include a granted patent that has been allowed to expire. An invention published is an invention that is published in at least one of, written form, video form and audio form. An invention published may also be referred to as a defensive publication.

### Industrial Applicability

The present disclosure is associated with a method of displaying information associated with intellectual property data on a geographic map region. In one embodiment a user desires to determine information associated with an invention. A query is formulated by the user and entered through the user interface 102. The query may include information associated with at least one of a topic, an attribute, and a term. For example, if the user wants to determine the coverage of a particular invention (e.g. issued U.S. Pat. No 5,555,555) then the query would include U.S. Pat. No. 5,555,555 (the topic), and “region of coverage” (the attribute).

In one embodiment, a user interface may prompt the user for this information. For example, the user interface may include a data entry screen having the appropriate fields to be completed. A user may select a button associated with (or labeled) an invention, a mark, or a work of authorship. Then, based upon the selection, another data entry screen may appear with the applicable (or potential) fields to be completed. For example, if the “invention” button is activated, another screen may appear with data entry fields for: invention identifier, attribute, repository to be searched, etc. In one embodiment, these fields may be provided by using pull down menus (e.g., providing the possible attributes to chose from). In one embodiment, a pull down menu with the options of topic, attribute, and term may be provided. When topic is selected (or highlighted), the user may be prompted with another menu selection of: invention, mark and work of authorship. If invention is selected the user may be prompted to enter an identifier. For example, the serial number, patent number, or docket number.

The user may select (or highlight) the attribute option from the pull down menu. The user may then be provided another menu to select from one or more attributes, e.g., “region of coverage”, from a pull down menu. Other attributes may include, life remaining on the patent, patent abandoned, patent filed, and invention published.

In one embodiment, the user may identify a repository to search (e.g. USPTO, EPO etc.) in the query. The repositories to be searched may be provided through a pull down menu or through a dialogue box. If no repository is identified, the default may be to search one or more local repositories. For example, a local repository may include information about the companies' inventions. Alternatively, the user may request all relevant foreign databases (e.g., foreign patent or trademark offices) be searched.

In one embodiment, depending on the repository to be searched, the user interface 102, or controller 104 may translate the user specified identifier (e.g. U.S. Pat. No. 5,555,555) to the appropriate identifier. That is, if the EPO repository is being searched, the United States patent number is translated into an identifier the EPO uses. In one embodiment, the repository to be searched may have a list of cross references (e.g., internal docket number, U.S. or foreign patent application number, U.S. or foreign patent number).

The controller 104 retrieves the query results from the repository. The query results may include countries in which U.S. Pat. No. 5,555,555 was issued.

For example, if a local repository is searched, the data retrieved from the repository may include the countries in which the patent was filed in, and the associated status (e.g., pending, issued, abandoned). The controller 104 then associates a code with a map region. In particular, the controller 104 will make the association based on intellectual property data and query attributes. For example, the controller 104 will analyze the retrieved data with respect to the attribute “coverage”, i.e. where is the application issued, pending, or abandoned. A color code green may be assigned to patent issued. The geographic map region would be displayed in response to the association. Therefore, the color green would be displayed in all geographic map regions in which U.S. Pat. No. 5,555,555 was issued. For example, if U.S. Pat. No. 5,555,555 were issued in the United States, the geographic map region of the United States would be colored green and displayed. The color code may associate patent pending with the color blue, and patent abandoned with the color red, and all others with the color gray.

So if the invention was issued in the United States, pending in Germany, and abandoned in Japan, the respective regions would be displayed as United States green, Germany blue, and Japan red.

In one embodiment, if the attribute selected were “life remaining” instead of “coverage” or in addition to “coverage”, the controller would analyze the retrieved information with respect to life remaining on the invention. For example, if the retrieved information would include information associated with filing data for the United States application, e.g., Jan. 1, 2000, and the current data was Jan. 1, 2002, the life remaining would be 18 years. The color code may be assigned different shades of a color (e.g., green) to issued patents (or pending applications) based on their life remaining. For example, issued patents may be shaded one of twenty shades of green, with the lightest green indicating there is one year left, and the darkest green indicating there is twenty years left in the life of the patent. Alternatively, different colors may be assigned based on the life of the patent. For example, the color code red may be assigned to patents having less than 5 years remaining, the color yellow with 6-10 years remaining, the color blue with 11-15 years remaining and the color green with 16-20 years remaining.

In one embodiment, a user may desire to see a visual indication of the value of a portfolio (e.g., region of coverage, life remaining, issue ratio, numbers in a region etc.). In one embodiment, the user may select “invention” from the topic pull down menu, then “invention portfolio” from a second pull down menu. The user may be prompted to enter the invention portfolio identifier, or key word. An invention portfolio may include a grouping of technologies, e.g. a grouping of technologies may be “Internet” technologies, “medical” technologies etc. For example, “medical” technologies may be all those inventions related to the medical field. The repository searched may have a category labeled medical technologies, which include identifiers associated with each invention associated with the medical technology. Alternatively, the repository may be searched for inventions related to the key words “medical technology”. In this example assume there are ten “medical” technology inventions.

Six of the inventions are patents issued, three of the inventions are patents pending and one of the inventions is abandoned. The color code green may be assigned for patent issued, blue for patent pending and red for patent abandoned. In the above example, the geographic map region associated with patents issued would be shaded green, blue for patent pending and red for patent abandoned. In one embodiment, a color associated with each patent application may be illustrated in a particular geographic region. For example, if three of the patents were filed in Germany (one issued, one pending, and one abandoned), then there would be three colors (green, blue, and red) covering portions of Germany. In addition, a cumulative value of a portfolio may be color coded in the geographic map region. For example, assume the color green represents a strong portfolio presence in a particular country, blue a moderate presence, and red a weak presence. Then assume a value of 1 is assigned to an abandoned patent in a county (not including patents that have issued and expired), a value of 2 is assigned to a patent pending and a value of 3 is assigned to an issued patent. Then the values may be assigned to the patents/applications of the portfolio. The portfolio value may be determined by adding the values of the patents/applications associated with a particular country. In one embodiment, an average portfolio value may be used to illustrate the geographic map region (e.g., cumulative values divided by the number of patents/applications associated with the country). For example, if the average value was 2.4, then this may be a sign of a strong portfolio and the country is displayed with the color green. Alternative forms of determining a portfolio value may be used. For example, the cumulative value of the portfolio may be established, and used to shade the geographic region accordingly. The higher the score the darker shade of green is used to illustrate the country. In addition, the remaining life of the issued patents may be accounted for. For example, the older the patent (i.e., less remaining life), then the lower the value associated with the patent and therefore, the lower the overall portfolio value is for displaying (e.g., lighter shade of green). In addition, the color coding may be used to represent the ratio of issued patents to abandoned patents (e.g., as an indicator of prosecution success rate). The higher the ratio, the darker the region may be shaded (e.g., green). The lower the ratio, the lighter the color, unless the ratio is less than one. If the ratio is less than one, then the lower the ratio the darker the shade of red.

In one embodiment, a user may want to know where marks are registered, the strength of the marks, etc. The user may select “mark” (the topic) in a first data entry screen, thereby prompting the display of a second display screen which provides data entry prompts, or pull-down menus for additional relevant options, e.g., the mark term, attributes associated with the mark (e.g., region of coverage, class of the mark, class to be searched, classes of similar marks found, strength of mark, the goods/services associated with the mark etc.), and repository or classes to be searched. Alternatively, a series of pull down menus may be used (as discussed). In one embodiment, the user selects “mark” from the topic pull down menu and is prompted to enter the mark name (or derivation thereof). The user may also enter the class to be searched, if a particular class search is desired. The user may enter one or more attributes associated with the mark, or select the attributes from a pull down menu. For example, the user may select “grammatically similar” or “strength of mark” from the attribute pull down menu. In this instance, a query including the core word “Caterpillar” is entered and the controller queries at least one repository with the core word “Caterpillar” and compares the results for a “grammatically similar” words, and determines what classes the similar words are located in (if a class to be searched was not specified), and what goods or services are associated with the registered mark. The repository to be searched may be located in one or more foreign trademark offices. The user interface, or controller, may automatically access the designated repositories. The words returned from the query may be similar to the core word “Caterpillar”, such as “Katerpillar”, “Catterpillar”, “Katterpillar”, etc. from one or more countries. A color code may be assigned to the geographic map regions having words that are “grammatically similar”. In the above example, the geographic map region associated with “grammatically similar” words would be shaded blue, e.g. if “Katterpillar were a mark registered in Germany, “Catterpillar” a mark registered in France and “Katterpillar” a mark registered in Japan, the three countries, Germany, France and Japan would be shaded blue on a geographic map. In one embodiment, the query may search multiple classes for a similar mark. In this embodiment, the class of the similar mark may be returned and displayed.

In one embodiment, the user selects “mark” from the topic pull down menu, and the mark is entered. Then “partial mark” may be selected from the attribute pull down menu. In this instance, a core word “Caterpillar” is entered and the controller queries at least one repository with the core word “Caterpillar” and compares the results for a “partial mark”, e.g. the “partial mark” returned may be “cat” “cater”, “pillar”, etc. In the above example, the geographic map region associated with “partial mark” words may be shaded red, e.g. if “cat” were a registered mark in Kenya, “cater” a registered in New Zealand and “pillar” a registered mark in Canada, then the three countries Kenya, New Zealand and Canada would all be shaded red on a geographic map.

In one embodiment, the user may select “work of authorship”.

Selecting “work of authorship” may prompt the display of a screen requesting additional information, e.g., the title or subject matter of the work. The user interface 102, or controller 104 may then search one or more repositories to determine if the work has been registered, and if so, where.

Other aspects, objects and advantages of this invention can be obtained from a study of the drawings, the disclosure and the appended claims.

What is claimed is:

1. A computer implemented method of displaying at least one geographic map region, the method comprising the steps of:
retrieving data associated with intellectual property from at least one repository;
associating said geographic map region with a code in response to said data; and
displaying said region in response to said association.

2. The method as set forth in claim 1, wherein the step of retrieving said data includes the step of querying at least one of said repositories.

3. The method of claim 2, wherein said query includes information associated with at least one of a term, a topic and an attribute.

4. The method of claim 3, wherein said term includes at least one of a word, a phrase, a number, and symbol.

5. The method of claim 3, wherein said topic includes information associated with at least one of an invention, a mark, and a work of authorship.

6. The method of claim 5, wherein said invention includes information associated with at least one of, a patent, a patent application, a technology, a process, and an invention portfolio.

7. The method of claim 3, wherein said attribute includes at least one of a region of coverage, a life remaining on said intellectual property, a portfolio, a term of coverage, a strength of said mark, a core term, a similarity with said core term, a patent filed, a patent issued, a patent abandoned and an invention published.

8. The method of claim 3, wherein said step of associating said geographic map region further comprises the step of analyzing said intellectual property data in response to said at least one of said term, said topic and said attribute.

9. The method of claim 8, wherein said code may be at least one of, a color-code, a line-code, a shading-code and a three-dimension code.

10. The method of claim 8, wherein said association is performed with at least one of, human intervention and without human intervention.

11. A computer system configured to display at least one geographic map region, the system comprising:
at least one repository configured to store intellectual property data;
a controller configured to retrieve intellectual property data from said repository, and associate said geographic map region with a code in response to said intellectual property data, and send said data to an output device for display of said geographic map region in response to said association; and
an output device configured to receive said information associated with said code, and responsively display said geographic map region.

12. A system, as set forth in claim 11, wherein said at least one repository contains intellectual property data associated with at least one of a mark, an invention, and a work of authorship.

13. A system, as set forth in claim 11, wherein said invention data includes information associated with at least one of, a patent coverage, a life remaining, an amended coverage, a portfolio coverage, and a competitor portfolio coverage.

14. A system, as set forth in claim 11, wherein said information associated with said work of authorship data provided includes at least one of an age, an enforcement and a compliance with the Berne Treaty.
